(19) United States
(12) Patent Application Publication
(10) Pub. No.: US 2006/0040162 A1
(43) Pub. Date: Feb. 23, 2006

(54) Fuel cell and method for its manufacture

(76) Inventors: Joseph J. Jurica, Clinton, MI (US); Edward J. Engler, Farmington Hills, MI (US); Dave Hoffmann, White Lake, MI (US)

Correspondence Address: GIFFORD, KRASS, GROH, SPRINKLE & CITKOWSKI, P.C, PO BOX 7021, TROY, MI, 48007-7021, US

(21) Appl. No.: 11/204,810

(22) Filed: Aug. 16, 2005

Related U.S. Application Data
(60) Provisional application No. 60/602,279, filed on Aug. 17, 2004.

(51) Int. Cl. H01M 8/02; H01M 2/08; B21D 1/02

(52) U.S. Cl. 429/34; 429/35; 72/112

(57) ABSTRACT

A method for making a component of a fuel cell utilizes a rotary die forming station for shaping a web of material into a configuration corresponding to the component. The component may comprise an exchanger plate. Also disclosed is a method for fabricating a fuel cell assembly wherein a gasket is affixed between portions of two exchanger plates, and the affixation may be accomplished by rotary die forming. Also disclosed are fuel cells and fuel cell assemblies made by these methods.

### RELATED APPLICATION

This application claims priority of U.S. Provisional Patent Application Ser. No. 60/602,279 filed Aug. 17, 2004 and entitled “Fuel Cell and Method for Its Manufacture.”

### FIELD OF THE INVENTION

This invention relates generally to fuel cells. More specifically, the invention relates to fuel cells having a component thereof, such as an exchanger plate, which is fabricated by a rotary die forming process.

### BACKGROUND OF THE INVENTION

Fuel cells are electrochemical devices which operate to react fuels, such as hydrogen, methane, ethanol, methanol and the like, with an oxidizer so as to oxidize the fuel and generate an electrical current. Fuel cells are inherently silent and nonpolluting, and can provide relatively high density power sources. As a consequence, fuel cells are enjoying increasing popularity as stationary power sources as well as power sources for vehicles.

A typical fuel cell includes at least one pair of electrodes which are separated by a body of membrane material. The fuel cell also includes passages for introducing the fuel and oxidizer and venting reaction byproducts, and terminals for withdrawing electrical power therefrom. A typical fuel cell also includes a number of members referred to as exchanger plates. These plates serve to support the fuel cell membrane, electrode material and other such components. They also may be configured to define passages for the delivery of fuel and venting of reaction products. In some instances, the plates themselves can be configured to operate as electrodes, and in this regard, they may include specialized electrochemical coatings or laminated layers thereupon. The exchanger plates are typically fabricated from relatively thin metallic stock. High power fuel cell assemblies generally include a relatively large number of exchanger plates. These plates are typically fabricated from relatively thin stock, and are of a fairly precise configuration.

The present invention is directed to methods and apparatus for manufacturing exchanger plates and similar components of fuel cells. The method and apparatus of the present invention provides for the high speed, low cost manufacture of these components.

### BRIEF DESCRIPTION OF THE INVENTION

Disclosed herein is a method for making a component of a fuel cell. The method comprises the steps of providing a web of material, providing a rotary die forming station configured to shape said web of material into a configuration corresponding to the component of the fuel cell, and feeding the web through the station so that the station configures the web into a shape corresponding to the component. In specific embodiments, the web is comprised of metal, and the component may comprise an exchanger plate for the fuel cell. The rotary die forming station may be operable to carry out at least one operation on the web such as scribing, embossing, piercing, crimping, cutting, creasing, folding, stretching and bending.

In particular embodiments, the rotary die forming station can also apply a coating to the web such as an adhesive coating or an electrochemically active coating. The coating may be laminated onto the web or otherwise applied. Such coatings may comprise gasket materials, membranes and the like.

In another aspect of the present invention, a fuel cell assembly is prepared by disposing a gasket between a portion of a first exchanger plate and a second exchanger plate and deforming at least one of the plates or the gasket so as to fixedly retain the gasket to at least one of the plates. The deforming step may be carried out in a rotary die forming apparatus. In further embodiments, a fuel cell membrane may be disposed between at least a portion of the plates.

Also disclosed herein are fuel cells and fuel cell assemblies manufactured according to the methods of the present invention.

### BRIEF DESCRIPTION OF THE DRAWINGS

FIG. 1 is a perspective view of an exchanger plate for a fuel cell, which may be fabricated in accord with the present invention;

FIG. 2 is a partial cross-sectional view of a portion of a fuel cell assembly showing the affixation of a separator gasket thereto; and

FIG. 3 is a top plan view of the portion of the fuel cell assembly of FIG. 2.

### DETAILED DESCRIPTION OF THE INVENTION

The present invention employs a rotary die forming process for the manufacture of the fuel cell components. As is known in the art, rotary die forming processes employ a set of specifically configured dies which rotate into engagement with one another and operate to process a web of material passing therebetween. The dies may be configured to carry out a diverse group of operations including cutting, stretching, creasing, folding, embossing, piercing, scribing, bending, crimping, and the like. Rotary die forming processes and equipment are disclosed in the art, as for example in U.S. Patents RE37,366; U.S. Pat. Nos. 5,417,132 and 4,247,940, the disclosures of which are incorporated herein by reference. The rotary die forming processes of the present invention may be carried out at relatively high speeds on a continuous basis so as to configure a continuous web passing therethrough into various components of a fuel cell assembly.

The system of the present invention may include one or more rotary die forming stations disposed in a series or parallel relationship, and may also include further stations which can implement coating and laminating operations. For example, the system can also operate to coat exchanger plates with electrode material, for example by laminating a coating thereonto. Alternatively, there may be included a station which spray coats, electro coats, or otherwise deposits the electrode material onto the plates being fabricated. The system of the present invention may also include a station which operates to laminate a membrane material, a gasket material or some other such material onto the plates being fabricated.

In an integrated system, there may be included stations for inspecting or testing the members being produced, stations for aligning members into a registry for subsequent assembly, as well as stations which assemble the components into finished fuel cells or fuel cell subassemblies.

Typically, a fuel cell assembly includes a plurality of electrodes or exchanger plates, which are spaced apart to accommodate a proton conductive membrane therebetween. The fuel cell also typically includes an electrolyte material in contact with the exchanger plates and the membrane. It is necessary to seal the fuel cell so that the electrolyte is retained therein, and in accord with one embodiment of the present invention, the fabrication techniques of the present invention may be utilized to fabricate such a seal.

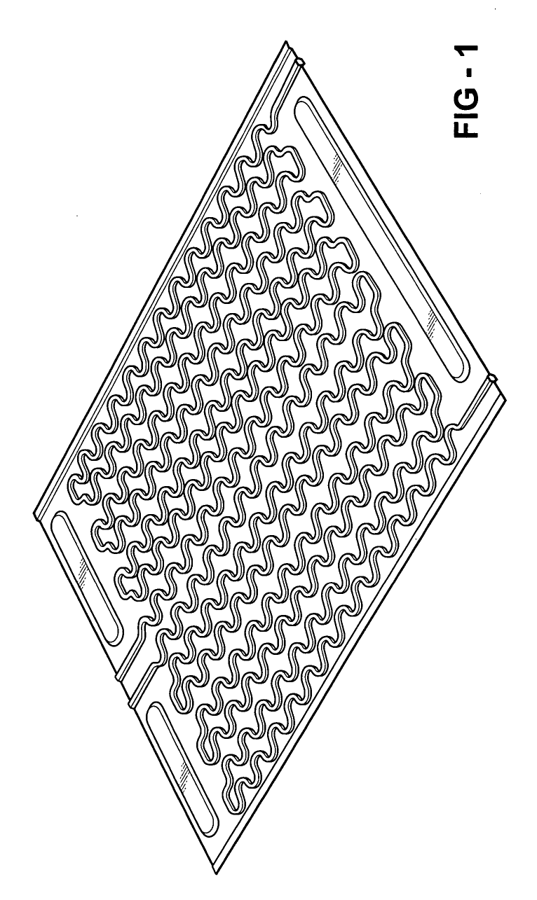

Referring now to FIG. 1, there is shown a perspective view of one configuration of an exchanger plate. The exchanger plate is generally planar and includes an opposed and generally spaced apart pair of faces. The exchanger plate may be fabricated according to the principles and methods of the present invention through the use of a rotary die forming operation. It is to be understood that plates that are otherwise configured may be likewise fabricated through the use of this invention.

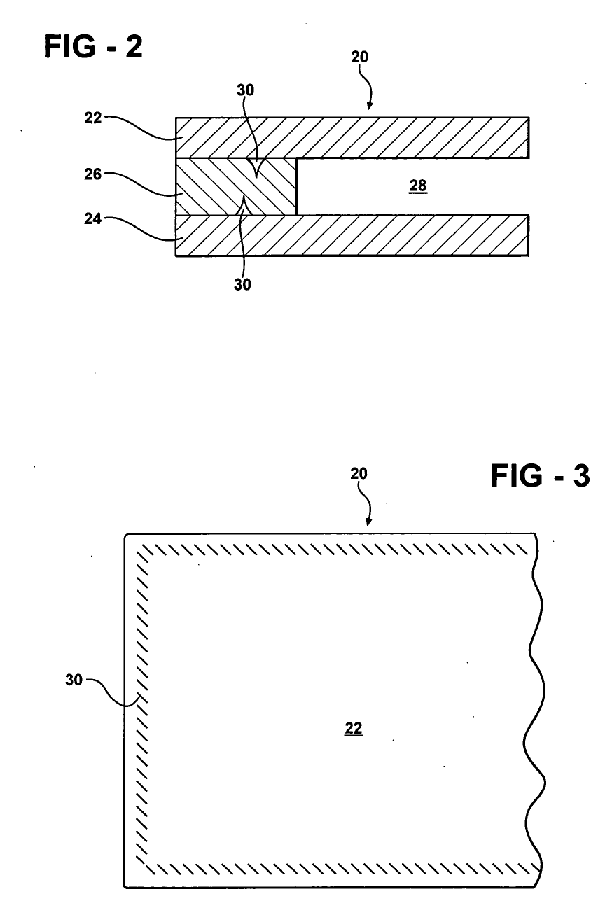

Referring now to FIG. 2, there is shown a cross-sectional view of a portion of a fuel cell 20 having a plurality of exchanger plates, each being similar to the one illustrated in FIG. 1. As illustrated, the fuel cell 20 includes a first exchanger plate 22 and a second exchanger plate 24, which are disposed in a spaced apart, superposed relationship relative to each other. A body of gasket material 26 is disposed in contact with opposing faces of the first 22 and second 24 plates. As described above, an electrolyte and membrane material are generally disposed in the space 28 between the plates 22 and 24. In accord with the present invention, the gasket material 26 is mechanically bonded to the plates 22 and 24 so as to effectuate a seal which encloses the interior volume 28. This may be accomplished by utilizing the rotary die forming process for crimping or piercing portions of the metal comprising the plates 22, 24 so as to interlock each plate into the gasket material 26 and, in some instances, into the other plate. In other instances, the bonding of the gasket and plate may be accomplished by thermal methods. For example, the gasket and/or plate may be heated by laser welding, induction welding, microwave heating or the like so as to effect a bond therebetween. It will be appreciated that in other embodiments, the gasket material may be eliminated and/or the membrane extended to the edges of the exchanger plates 22, 24.

Referring now to FIG. 3, there is shown a top plan view of the fuel cell 20 of FIG. 2 illustrating the mechanical interlock 30 disposed along the perimeter thereof. In some instances, an additional adhesive material may be applied to the gasket to facilitate the bonding. The adhesive may be applied during the die forming process, or may be impregnated into the gasket material itself.

It will be appreciated that the process of gasket cutting, bonding and placement, as well as the step of forming the mechanical interlock, may be readily implemented in connection with the rotary die forming process of the present invention so as to allow for the high speed, continuous manufacture of fuel cell assemblies. Thus, in accord with the present invention, an integrated fuel cell assembly line operating on a continuous web of material may be implemented. In a system of this type, an elongated web of metallic material is fed into the system. The web is configured into exchanger plates which are coated with electrode material, mated with gasket and membrane material, mechanically and possibly adhesively, interlocked, tested, sorted and assembled into stacks. These stacks may themselves be utilized as subassemblies of fuel cells, or may be shipped off for further assembly.

The present invention implements rotary die forming processes into the fabrication of fuel cell and fuel cell components. As such, the present invention provides for the efficient, low cost, high accuracy and high speed manufacture of such assemblies. In view of the teaching presented herein, one of skill in the art can readily adapt the present invention to other such electrochemical devices and applications. The foregoing is illustrative of specific embodiments of the invention but is not meant to be a limitation upon the practice thereof. It is the following claims, including all equivalents, which define the scope of the invention.

1. A method for making a component of a fuel cell, said method comprising the steps of:
providing a web of a material;
providing a rotary die forming station configured to shape said web of material into a configuration corresponding to said component; and
feeding said web through said station;
whereby said station configures said web into a shape corresponding to said component.

2. The method of claim 1, wherein said web comprises a web of a metallic material.

3. The method of claim 1, wherein said component is an exchanger plate.

4. The method of claim 1, wherein said rotary die forming station is operable to carry out at least one operation on said web, said operation selected from the group consisting of: scribing, embossing, piercing, crimping, cutting, creasing, folding, stretching and bending.

5. The method of claim 1, wherein said rotary die forming station is further operable to apply a coating to said web.

6. The method of claim 5, wherein said coating comprises an adhesive coating.

7. The method of claim 5, wherein said coating is electrochemically active.

8. The method of claim 1, wherein said station is further operable to laminate a material to said web.

9. The method of claim 8, wherein said material comprises a gasket material.

10. The method of claim 8, wherein said material comprises a membrane.

11. A fuel cell which includes a component made by the method of claim 1.

12. A method of making a fuel cell, said method comprising the steps of:
providing a first exchanger plate;
providing a second exchanger plate;
providing a gasket;
disposing said gasket on a portion of a face of said first plate;
disposing said second plate in a spaced apart, superposed relationship with said first plate so that a face of said second plate contacts said gasket; and
deforming at least one of said plates or said gasket so as to fixedly retain said gasket to at least one of said plates.

13. The method of claim 12, including the further step of deforming both of said plates so as to fixedly retain said gasket thereto.

14. The method of claim 12, wherein the step of deforming comprises crimping and/or piercing.

15. The method of claim 12, including the further step of interposing a fuel cell membrane between at least a portion of the spaced apart regions of said first and second plate.

16. The method of claim 12, wherein said step of deforming is implemented by a rotary die forming process.

17. The method of claim 12, wherein said step of deforming comprises heating.

18. A fuel cell including at least one component which is fabricated in a rotary die forming process.
